(19) United States
(12) Patent Application Publication
(10) Pub. No.: US 2019/0070524 A1
(43) Pub. Date: Mar. 7, 2019

(54) DEVICES, SYSTEMS, AND METHODS FOR SPLITTING FLUID FLOWS WITH POROUS MEDIA

(71) Applicant: MOTT CORPORATION, Farmington, CT (US)

(72) Inventors: Christopher MARTINO, Berlin, CT (US); Allen BEAUNE, Norfolk, CT (US); James K. STEELE, Rockfall, CT (US); Kenneth L. RUBOW, Avon, CT (US); Matthew C. SIOK, Farmington, CT (US); Sean JAMESON, Bristol, CT (US)

(21) Appl. No.: 16/123,074

(22) Filed: Sep. 6, 2018

Related U.S. Application Data
(60) Provisional application No. 62/554,814, filed on Sep. 6, 2017.

(51) Int. Cl. B01D 15/18; G01N 30/46; B01D 15/34

(52) U.S. Cl. CPC B01D 15/1878; G01N 30/465; B01D 15/34; G01N 30/463

(57) ABSTRACT

Various embodiments are generally directed to techniques for splitting fluid flows with porous medium, such as a porous medium with metal particles, for instance. Some embodiments are particularly directed to a flow splitting assembly that creates a differential flow at a calibrated flow split. In one or more embodiments, for example, an apparatus for flow spitting may include a manifold comprising first, second and third manifold openings in fluid communication. In one or more such embodiments, introduction of a flow to the first manifold opening via an inlet filter may cause a differential flow at a calibrated flow split between a first restrictor coupled to the second opening of the manifold and a second restrictor coupled to the third opening of the manifold. In various embodiments, each restrictor may include one or more porous medium composed of metal particles.

### PRIORITY

This application claims the benefit of priority under 35 USC § 119 to U.S. Provisional Patent Application Ser. No. 62/554,814, filed Sep. 6, 2017, which is incorporated by reference herein in its entirety and for all purposes.

### BACKGROUND

Flow splitting devices may be used in flow systems, such as for separation techniques in analytical chemistry. Typically, separation techniques in analytical chemistry may be used to separate fluid streams. For instance, flow splitting devices may be used in separation techniques such as high performance liquid chromatography (HPLC), ultra-high performance liquid chromatography (UHPLC), and liquid chromatography with mass spectroscopy (LC/MS). In such instances, flow splitting devices may be used in pre-column or high pressure splitting and/or post-column or low pressure splitting. Typically, the separation of the fluid streams may enable analysis of pharmaceuticals and/or quality control procedures in multiple methods. In some instances, the analytes are products of organic reactions, such as peptides and/or proteins.

### SUMMARY

Various embodiments are generally directed to techniques for splitting fluid flows with porous medium, such as a porous medium with metal particles, for instance. Preferred materials for use in the embodiments described herein may include one or more of nickel, cobalt, iron, copper, aluminum, palladium, titanium, tungsten, platinum, silver, gold, and alloys and oxides thereof including one or more of stainless steels and nickel-based steels, such as Hastelloy® (Haynes Stellite Company, Kokomo, Ind.). Further, in some embodiments, one or more of ceramic, glass, and various polymer materials may be used.

Some embodiments are particularly directed to a flow splitting assembly that creates a differential flow at a calibrated flow split. In one or more embodiments, for example, an apparatus for flow splitting may include a manifold comprising first, second, and third manifold openings in fluid communication with each other. An inlet filter may be coupled to the first manifold opening. A first restrictor may be coupled to the second manifold opening. The first restrictor may include a first porous media. A second restrictor may be coupled to the third manifold opening. The second restrictor may include a second porous media. Introduction of a fluid flow to the manifold via the inlet filter may cause a differential flow at a calibrated flow split between the first and second restrictors. The differential flow may include a first sub-flow through the first restrictor and a second sub-flow through the second restrictor. The first porous media and the second porous media may include porous metal. The porous metal may include stainless steel. The porous metal may include porous metal sinterable particles including a metal or metal alloy that may include nickel, cobalt, iron, copper, palladium, titanium, platinum, silver, and/or gold. At least one of the first porous media and second porous media may include a polymer material. At least one of the first porous media and the second porous media may include ceramic or glass material. The first porous media may include a first set of one or more porous mediums. The second porous media may include a second set of one or more porous mediums. Each porous medium in the first and second sets may be associated with a predefined flow resistance value. The calibrated flow split between the first and second restrictors may be based on a ratio of a first combined flow resistance value of the first sub-flow to a second combined flow resistance value of the second sub-flow. The first combined flow resistance value may be based on the predefined flow resistance values of each porous medium in the first set. The second combined flow resistance value may be based on the predefined flow resistance values of the second set. The first combined flow resistance value may be based on a first downflow resistance in fluid communication with the first restrictor. The second combined flow resistance value may be based on a second downflow resistance in fluid communication with the second restrictor. One or more of the first and second downflow resistances may include tubing. The one or more porous mediums in the first set may be arranged in series. The one or more porous mediums in the second set may be arranged in series. The first set of porous mediums may be arranged in parallel with the second set of porous mediums. Each porous medium in the first and second sets may include porous metal. The porous metal may include stainless steel. The first restrictor may include first and second restrictor openings in fluid communication via a restrictor interior volume. The first restrictor opening may be coupled to the second manifold opening. The first porous media may be disposed within the restrictor interior volume. The second restrictor opening may be coupled to a tube in fluid communication with a sensor. The first porous media may include a powder of metal particles. The powder of metal particles are compressed into a cylindrical or disc shape. A flowrate, F₁, of the flow and a flowrate, F₂, of the first sub-flow may have the following relationship with a thickness, T₂, of the first porous medium, a thickness, T₃, of the second porous medium, a permeability, k_{L2}, of the first porous medium, a permeability, k_{L3}, of the second porous medium, a diameter of the first porous medium, and a diameter of the second porous medium: F₂=F₁/(1+(T₂/T₃)(k_{L2}/k_{L3})(D₃²/D₂²)). A polyether ether ketone (PEEK) may be configured to form a seal between one or more of the inlet filter and the first manifold opening, the first restrictor and the second manifold opening, and the second restrictor and the third manifold opening. The seal may include a high-pressure seal of at least 5,000 pounds per square inch (PSI). The first porous media and the second porous media may include stainless steel. A pre-column splitter may include the manifold, the first restrictor, and the second restrictor. A post-column splitter may include the manifold, the first restrictor, and the second restrictor.

In various embodiments, a method for splitting fluid flows with porous media may include introducing a fluid flow to a manifold via an inlet filter. The manifold may include a first, a second, and a third manifold opening in fluid communication with each other. The inlet filter may be coupled to the first manifold opening. A first restrictor may include a first porous media coupled to the second manifold opening. A second restrictor may include a second porous media coupled to the third manifold opening. A differential fluid flow may be caused at a calibrated flow split between the first and second restrictors. The differential flow may include a first sub-flow through the first restrictor and a second sub-flow through the second restrictor.

In various embodiments, a method of manufacturing a flow restrictor may include compressing metal powder particles into a first porous medium. The first porous medium may have a first predefined flow resistance value. The metal powder particles may be compressed into a second porous medium. The second porous medium may have a second predefined flow resistance value that may be different than the first predefined flow resistance value. The first porous medium and the second porous medium may be disposed in an interior volume of a restrictor. The restrictor may include first and second openings in fluid communication via the interior volume. The metal powder particles may be compressed into the first porous medium as part of a first sintering process based on the first predefined flow resistance value. The metal powder particles may be compressed into the second porous medium as part of a second sintering process based on the second predefined flow resistance value. The first porous medium may include a first cylinder with a diameter and a first thickness. The first thickness may be perpendicular to the diameter. The second porous medium may include a second cylinder with a diameter and a second thickness. The second thickness may be perpendicular to the diameter. The first thickness may be based on the first predefined flow resistance value. The second thickness may be based on the second predefined flow resistance value. The metal powder particles may be compressed into the first porous medium with a first pressing force based on the first predefined flow resistance value. The metal powder particles may be compressed into the second porous medium with a second pressing force based on the predefined flow resistance value. One or more dimensions of the first porous medium may be determined based on the first predefined flow resistance value. One or more dimensions of the second porous medium may be determined based on the second predefined flow resistance value. The metal powder particles may include stainless steel. The first porous medium and the second porous medium may be disposed in series. The first porous medium and the second porous medium may be disposed by stacking the first porous medium and the second porous medium in the interior volume. The first porous medium and the second porous medium may have a cylindrical shape. The first porous medium and the second porous medium may include at least one surface with matching dimensions. A size in a dimension perpendicular to the surface with matching dimensions may be determined based on the first and second predefined flow resistance values, respectively.

These and other embodiments are described and claimed.

### BRIEF DESCRIPTION OF THE DRAWINGS

FIG. 1 illustrates an exemplary flow splitting assembly according to one or more embodiments described herein.

FIG. 2 illustrates an exemplary flow splitting assembly according to one or more embodiments described herein.

FIG. 3 illustrates exemplary sub-flows according to one or more embodiments described herein.

FIGS. 4A and 4B illustrate exemplary resistances according to one or more embodiments described herein.

FIGS. 5A-5B illustrate an exemplary restrictor according to one or more embodiments described herein.

FIGS. 6A and 6B illustrate an exemplary flow splitting assembly according to one or more embodiments described herein.

FIGS. 7A-7C illustrate an exemplary restrictor according to one or more embodiments described herein.

FIG. 8 illustrates an exemplary restrictor according to one or more embodiments described herein.

FIGS. 9A and 9B illustrate exemplary restrictors according to one or more embodiments described herein.

FIG. 10 illustrates an exemplary ferrule according to one or more embodiments described herein.

FIGS. 11A and 11B illustrate an exemplary restrictor according to one or more embodiments described herein.

FIGS. 12A-12D illustrate exemplary restrictors according to one or more embodiments described herein.

FIGS. 13A-13C illustrate exemplary restrictors according to one or more embodiments described herein.

FIG. 14 illustrates experimental flow split data according to one or more embodiments described herein.

FIGS. 15A-15E illustrate experimental flow versus pressure drop data according to one or more embodiments described herein.

FIG. 16 illustrates a graphical representation of data associated with flow splitting according to one or more embodiments described herein.

FIG. 17 illustrates a graphical representation of data associated with flow splitting according to one or more embodiments described herein.

### DETAILED DESCRIPTION

The present disclosure is not limited to the particular embodiments described. The terminology used herein is for the purpose of describing particular embodiments only, and is not intended to be limiting. Unless otherwise defined, all technical terms used herein have the same meaning as commonly understood by one of ordinary skill in the art to which the disclosure belongs.

As used herein, the singular forms “a,” “an,” and “the” are intended to include the plural forms as well, unless the context clearly indicates otherwise. The terms “comprises” and/or “comprising,” or “includes” and/or “including” when used herein, specify the presence of stated features, regions, steps elements and/or components, but do not preclude the presence or addition of one or more other features, regions, integers, steps, operations, elements, components and/or groups thereof. As used herein, the conjunction “and” includes each of the structures, components, features, or the like, which are so conjoined, unless the context clearly indicates otherwise, and the conjunction “or” includes one or the others of the structures, components, features, or the like, which are so conjoined, singly and in any combination and number, unless the context clearly indicates otherwise. The term “or” is generally employed in its sense including “and/or” unless the content clearly dictates otherwise.

All numeric values are herein assumed to be modified by the term “about,” whether or not explicitly indicated. The term “about”, in the context of numeric values, generally refers to a range of numbers that one of skill in the art would consider equivalent to the recited value (i.e., having the same function or result). In many instances, the term “about” may include numbers that are rounded to the nearest significant figure. Other uses of the term “about” (i.e., in a context other than numeric values) may be assumed to have their ordinary and customary definition(s), as understood from and consistent with the context of the specification, unless otherwise specified.

The recitation of numerical ranges by endpoints includes all numbers within that range, including the endpoints (e.g. 1 to 5 includes 1, 1.5, 2, 2.75, 3, 3.80, 4, and 5).

It is noted that references in the specification to “an embodiment”, “some embodiments”, “other embodiments”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to effect such feature, structure, or characteristic in connection with other embodiments, whether or not explicitly described, unless clearly stated to the contrary. That is, the various individual elements described below, even if not explicitly shown in a particular combination, are nevertheless contemplated as being combinable or arrangeable with each other to form other additional embodiments or to complement and/or enrich the described embodiment(s), as would be understood by one of ordinary skill in the art.

Some challenges facing flow splitting include devices that are inaccurate, clog, plug, and/or cause peak broadening. The challenges may result from the use of small diameter tubing, such as capillary tubing, that is highly susceptible to clogging or plugging. Clogging or plugging may lead to a drift in accuracy after repeated use due to changes in pressure in the system caused by physical clogging of a flow splitting device. Additionally, challenges may result from flow splitting devices having excessive internal volumes, which may lead to dispersion, for example. Dispersion may result from an analyte diffusing into the mobile phase, leading to decreased accuracy and/or peak broadening. Adding further complexity, may require time consuming and difficult customizations to optimize performance. In some embodiments, flow splitting devices may be utilized in conjunction with sensors or detectors that are optimized to operate under specific conditions, such as mass/volume tolerances. For instance, if an incoming analyte mass is high, the detector may be overloaded, resulting in a saturated signal. In such instances, tubing may have to be cut and arranged according to exacting specifications for reliable flow splitting. These and other factors may result in flow splitting devices with limited flexibility, low resolution, and/or poor performance. Such limitations may drastically reduce the capabilities, usability, and applicability of the flow splitting devices, contributing to inefficient devices with limited adaptability. Various embodiments described herein include a flow splitting device employed with a calibrated split flow ratio. In some embodiments, the flow splitting device may utilize two restrictors, each comprising a porous media to create a differential flow at the calibrated flow split. In some such embodiments, the two restrictors may be applied to two outlets of a manifold, such as a tee, to create a differential resistance in each leg, resulting in a differential flow determined by Darcy's flow in porous medium. In various instances, the flow through each leg may be adjusted by varying the thickness, diameter, and/or permeability of the porous media in the restrictors. In various such instances, each porous media may include a set of one or more porous mediums that act as a flow resistor. In one or more embodiments, each of the porous medium may be associated with a predefined flow resistance value. In one or more such embodiments, the numbers and/or types of porous medium in each set may be adjusted to achieve a desired calibrated flow split. In these and other ways one or more of the flow splitting devices described herein may split flows in an accurate and efficient manner to achieve improved flow splitting techniques, resulting in several technical effects and advantages.

The various embodiments of devices and systems of the present disclosure may be manufactured using exemplary methods and/or include exemplary features including, but are not limited to, those described in commonly owned U.S. Pat. Nos. 6,152,162 and 6,422,256, and International Patent Cooperation Treaty Application No. PCT/US2016/069487, each of which are herein incorporated by reference in their entirety and for all purposes.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modification, equivalents, and alternatives within the scope of the claims.

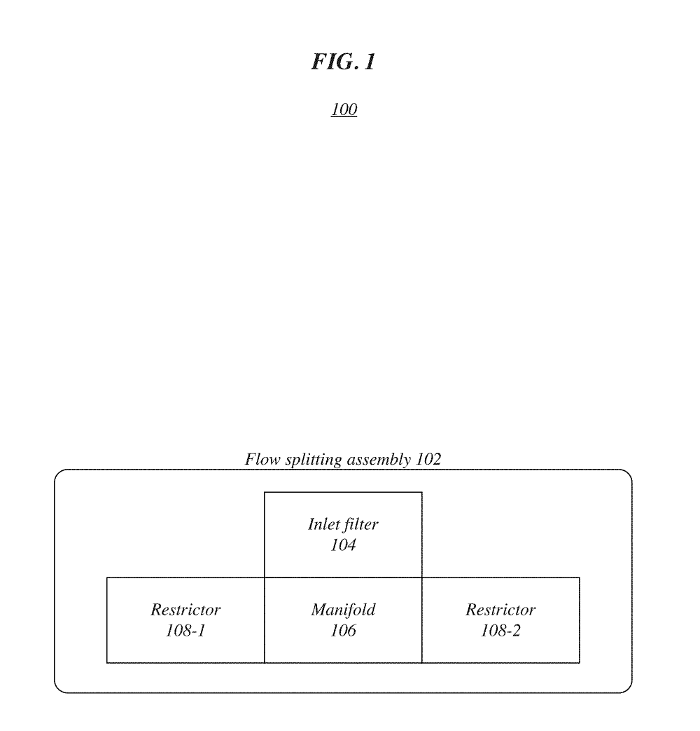

FIG. 1 illustrates an embodiment of an operating environment 100 that may be representative of various embodiments. Operating environment 100 may include a flow splitting assembly 102 (also referred to as “flow splitter”). In one or more embodiments described here, the flow splitting assembly 102 may create a differential flow at a calibrated flow split. In various embodiments, a flow splitting assembly 102 may include or be referred to as a flow splitter or flow splitting device. In some embodiments, the flow splitting assembly 102 may include an inlet filter 104, a manifold 106, a first restrictor 108-1, and a second restrictor 108-2. In some such embodiments, flow the splitting assembly 102 may utilize two or more restrictors (e.g., restrictor 108-1 and restrictor 108-2) to create a differential flow at a calibrated flow split between the two or more restrictors, such as between the first restrictor 108-1 and the second restrictor 108-2. Embodiments are not limited in this context.

One or more embodiments of flow splitting devices described herein and/or one or more components thereof may be used in flow systems. In some embodiments, the flow system may implement analytical techniques for the separation of analytes, such as high performance liquid chromatography (HPLC) and Liquid or Gas Chromatography with Mass Spectroscopy (LC/MS; GC/MS) techniques. For example, an analyte may undergo chromatic separation in an analytical column before passing through an ultraviolet (UV) light detector. In various embodiments, the flow system may include multiple detectors or sensors. For instance, pre-column splitting may be desired for nano-LC when an HPLC pump is used, or two columns are used. In one or more embodiments, two columns will give a flow system two dimensions of separation. Such flow systems may be referred to as 2D-chromatography flow systems. In one or more such embodiments, each column may go to a different detector. In various embodiments, a second flow splitting assembly may be utilized to recombine the flow.

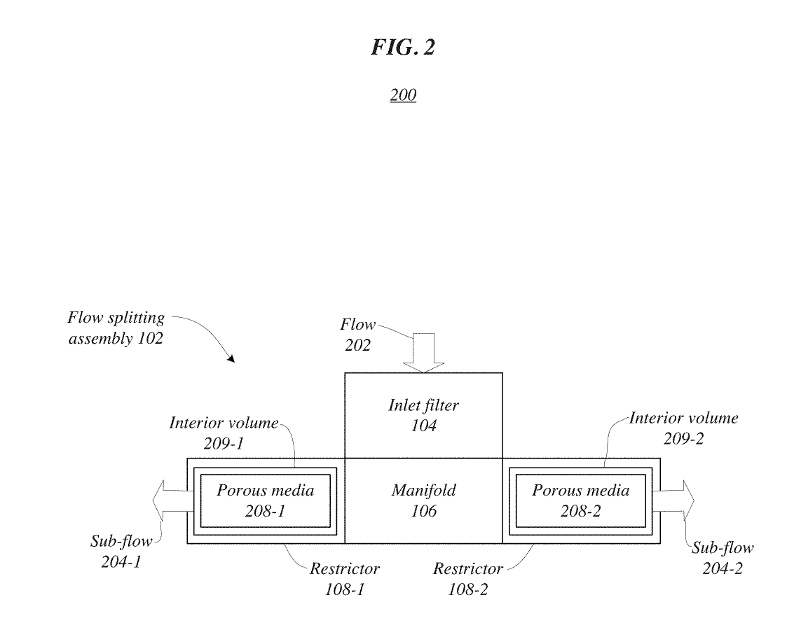

In some embodiments, post-column splitting may be desired when two detectors are being used for analysis, such as in LC/MS, Liquid Chromatography with Electrochemical Detection (LC/ECD), and other methods of HPLC. In one or more embodiments, a flow splitter may be used post-column to optimize a flow of liquid (e.g., sub-flow 204-1 of FIG. 2) going into a detector. In one or more such embodiments, a second flow (e.g., sub-flow 204-2 of FIG. 2) may be collected as waste. In various embodiments, the detectors are mass/volume sensitive and/or optimized to operate under specific conditions. Various embodiments described herein includes a flow splitting assembly that can deliver a flow optimized for a detector while compensating for a range of different inlet flows. In embodiments, the flow splitter can provide a calibrated split flow ratio. In such embodiments, the flow detector may prevent sensors from detecting saturated signals.

In various embodiments, a manifold may comprise plastic, glass, ceramics, metals, metal alloys, or the like. Such may be manufactured using techniques such as casting, molding, three-dimensional printing, or the like.

FIG. 2 illustrates an embodiment of an operating environment 200 that may be representative of various embodiments. In operating environment 200, a differential flow at a calibrated flow split is created by splitting flow 202 into sub-flow 204-1 and sub-flow 204-2. For instance, flow 202 may be input into flow splitting assembly 102 via inlet filter 104. From inlet filter 104, flow 202 may then enter manifold 106 and be forced to exit manifold 106 via restrictor 108-1 or restrictor 108-2, resulting in a calibrated flow split of flow 202 into sub-flow 204-1 and sub-flow 204-2. In various embodiments, the calibration of the flow split may be adjusted by adjusting a flow resistance of each restrictor. In one or more embodiments, the flow resistance of restrictor 108-1 may be based on porous media 208-1 and the flow resistance of restrictor 108-2 may be based on porous media 208-2. Embodiments are not limited in this context.

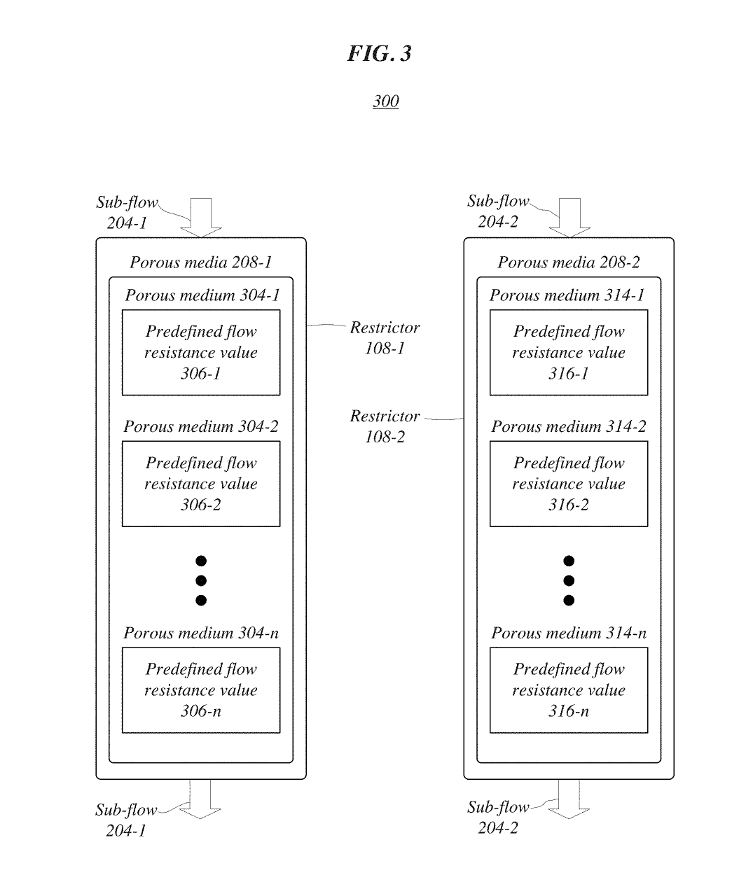

In several embodiments, the flow splitters described herein may provide a means of splitting a flow for liquid chromatography applications using one or more restrictors with a porous media. For instance, restrictor 108-1 may include porous media 208-1 disposed in interior volume 209-1 and restrictor 108-2 may include porous media 208-2 disposed in interior volume 209-2. In some embodiments, the porous media may include porous metal, such as porous stainless steel (e.g., compressed 316L stainless steel powder particles). In various embodiments, porous stainless steel mediums may be used to create a flow split. In various such embodiments, the flow split may be used in HPLC and/or LC/MS. In one or more embodiments, the application of a porous media to different legs or outlets (e.g., via restrictor 108-1 and restrictor 108-2) of a manifold, a differential resistance may be created in each leg that results in a differential flow that is determined by Darcy's flow in porous medium. In various embodiments, the flow splitter may be unaffected by the viscosity and/or gradient composition of the flow. In some embodiments, as will be described in more detail below (see e.g., FIG. 3), calibration of the split between the different legs may be achieved by changing the permeability, diameter, and/or thickness of porous media 208-1 in restrictor 108-1 and/or porous media 208-2 in restrictor 108-2.

In various embodiments, the flow splitting assembly 102, and/or components thereof, may have a small internal or interior volume (e.g., <10 μL). In various such embodiments, this may limit the dispersion of analyte peaks. In one or more embodiments, a small internal volume may be achieved by utilizing precision machining techniques in the construction of the flow splitter to deliver tight tolerance hardware at micro sizes. Dispersion may be a factor of increased volume where an analyte can experience diffusion into the mobile phase. In some embodiments, the greater interior volume, the greater the diffusion.

As previously mentioned, in one or more embodiments, liquid chromatography analysis may use multiple detectors, requiring a flow (e.g., flow 202) to be split into different flow fractions (e.g., sub-flow 204-1 and sub-flow 204-2). In some embodiments, different lengths of capillary tubing of small diameter (e.g., <0.005″) may be used to or assist in creating a differential flow. In some such embodiments, this may be due to the magnitude of restriction created, and when tubing is cut to different lengths a controlled flow split may be achieved. However, in embodiments that do not utilize inlet filter 104, the tubing may be prone to clogging or plugging. In one or more embodiments described herein, inlet filter 104 may prevent contaminants from entering manifold 106.

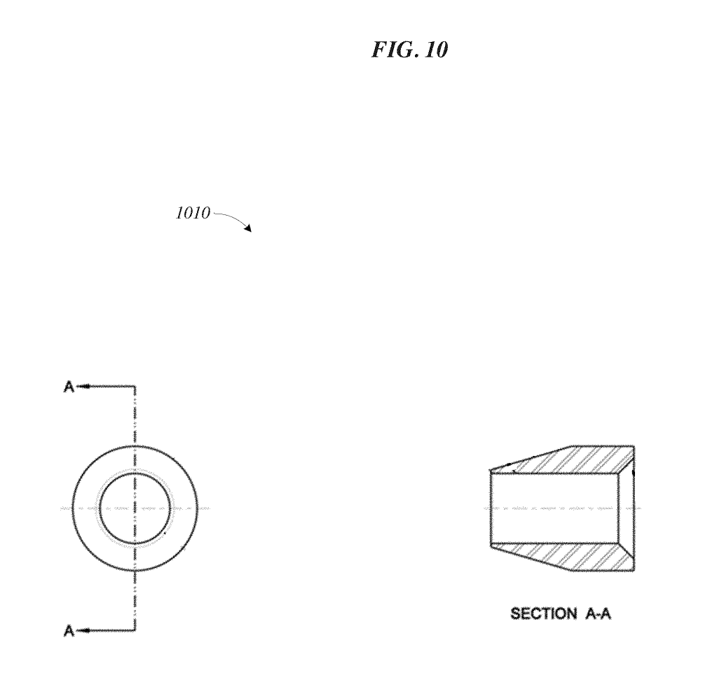

In some embodiments, inlet filter 104 may be readily replaced, such as by hand or with hand tools. For instance, finger tight fittings may be used in the construction of the splitter for ease of use and interchangeability. In some such embodiments, filter 104 may be readily replaced because it may be prone to clogging, such as from debris or mobile phase precipitation. In one or more embodiments, the connection between manifold 106 and one or more of inlet filter 104, restrictor 108-1, and restrictor 108-2 may utilize finger tight fittings. In various embodiments, the connections may be required to withstand high pressures, such as 12,000 pounds per square inch (PSI). In various such embodiments, a polyether ether ketone (PEEK) material may be used to seal connections (see e.g., FIG. 10). In some embodiments, the PEEK material may elastically deform to seal at the contact surface when using finger tight fittings.

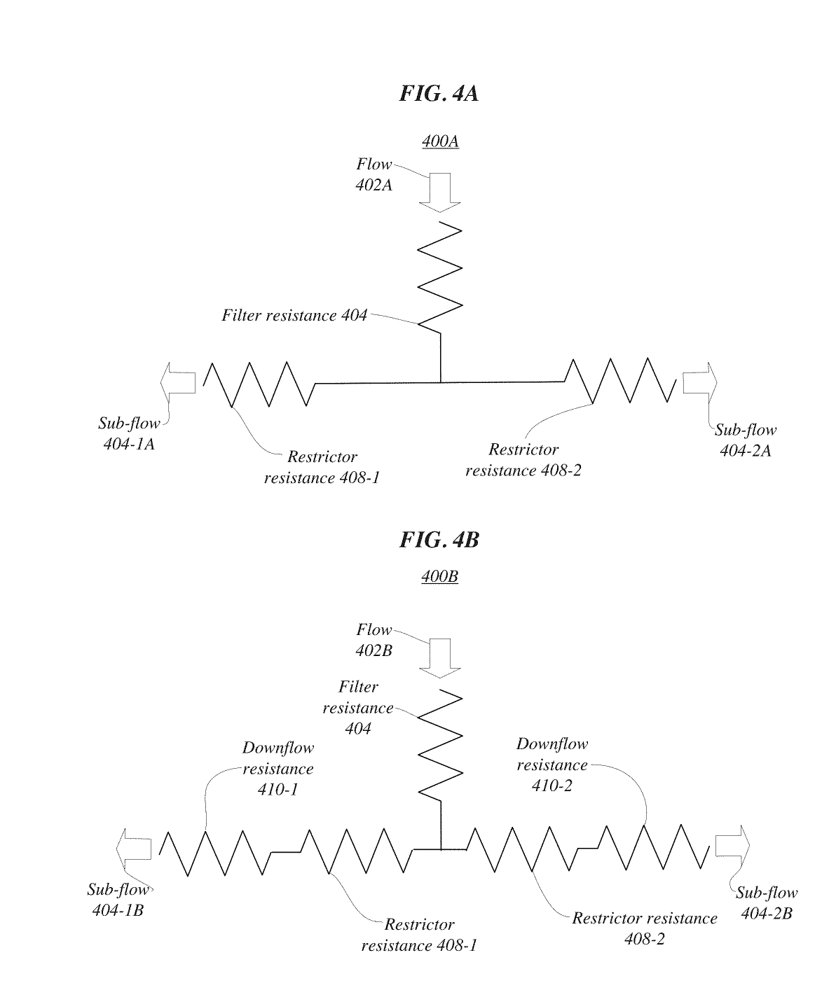

In various embodiments, the inlet filter 104 may couple with manifold 106 in a non-standard manner. For instance, there may be a lock-and-key style connection between inlet filter 104 and manifold 106. In various such embodiments, the non-standard connection may prevent flow splitting assembly 102 from being used without inlet filter 104 installed. In one or more embodiments, non-standard connections may also be used between manifold 106 and one or more of restrictors 108. In some embodiments, inlet filter 104 may be integrated into the inlet of manifold 106 and engineered such that the fitting cannot be used without the inlet filter 104. In various embodiments, inlet filter 104 may protect restrictors 108 from becoming plugged over time, and potentially causing a drift in the calibrated flow split of flow splitting assembly 102. In one or more embodiments, increased pressure at the splitter caused by downstream or downflow resistances (see e.g., FIG. 4B), which may include tubing, may lead to boiling of the liquid mobile phase, precipitation of mobile phase salts, and/or outgassing. For these or other reasons, inlet filter 104 may be designed for a long life (e.g., 6 months), and/or the internal volume may be minimized.

In one or more embodiments, flow splitting assembly 102 may be non-leachable and not contribute any particulate to an analysis stream. In one or more such embodiments, components of flow splitting assembly 102 may undergo a passivation flush followed by repeated flushing to wash away any possible contributing particulate. In various embodiments, one or more components of flow splitting assembly 102 may be constructed from stainless steel to limit leaching. For example, manifold 106 and the bodies of restrictors 108 may be constructed from 316L stainless steel.

FIG. 3 illustrates an embodiment of an operating environment 300 that may be representative of various embodiments. In operating environment 300, porous media 208-1 of restrictor 108-1 may include a first set of one or more porous mediums 304-1, 304-2, 304-n and porous media 208-2 of restrictor 108-2 may include a second set of one or more porous mediums 314-1, 314-2, 314-n. In one or more embodiments, each porous medium in porous media 208-1 and each porous medium in porous media 208-2 may be associated with a predefined flow resistance value. In one or more such embodiments, the predefined flow resistance value of each porous medium may be based on one or more of the shape, thickness, diameter, and permeability of the respective porous medium. For instance, porous mediums may be a disc or in a cylindrical shape. In some embodiments, a combined flow resistance value for each restrictor may be determined based on the collection of porous mediums in a respective porous media. In some such embodiments, different types and/or numbers of porous medium may be utilized in each porous media of each restrictor to achieve a desired flow split. Embodiments are not limited in this context.

In some embodiments, porous mediums 304-1, 304-2, 304-n may be disposed within interior volume 209-1 and porous medium 314-1, 314-2, 314-n may be disposed within interior volume 209-2. In some such embodiments, the porous mediums may be stacked or arranged in series within the interior volumes. In various embodiments, the first set of porous mediums (i.e., porous media 208-1) may be arranged in parallel with the second set of porous mediums (i.e., porous media 208-2). In one or more embodiments, flow splitting assembly may include any number of restrictors. In some embodiments, each restrictor may include any number of porous mediums.

In one or more embodiments, the flow splitter may include a passivated 316L stainless steel micro volume tee connected to replaceable hardware containing the porous media. In various embodiments described herein, a desired calibrated flow split of flow 202 into sub-flows 204-1, 204-2 may be achieved by selecting the one or more porous mediums in each porous media with desired attributes. For instance, varying the thickness, diameter, and/or permeability of the porous mediums included in each leg of a restrictor can tailor the flow split that is achieved. In some embodiments, porous media of a specific thickness can be used to create a high-pressure drop to mitigate the resistance created downstream of the splitter (see e.g., FIG. 4B), such as from tubing and/or resistance created by detectors/sensors.

In one or more embodiments, each porous medium may be made of metal powder particles, such as by pressing 316L stainless steel powder particles. In various embodiments, one or more of porous medias may include porous metals, mineral compounds (such as silica or the like), ceramics, plastics, high density foams, foam/powder composites, or a hybrid thereof. In the broadest sense, and as used in this application, the term “flow restrictor” or “flow resistor” encompass any three-dimensional porous structure that defines a through-flow matrix including a multiplicity of pores or passages through which gas flows such that, for a particular gas and over a range of pressures, the rate of gas flow through the structure depends on the pressure drop across the structure and the pressure drop-flow rate characteristics are well defined. In some embodiments, one or more of the particle size of the powder, dye fill, pressing force, sintering process, and sintering time may dictate the thickness and permeability of the porous medium. In various embodiments, one or more porous mediums may be placed in series in each restrictor to achieve a desired pressure drop across the restrictor, which can be correlated to a specific liquid volume flow based on Darcy's laminar flow through porous media. The difference in pressure may be calculated using Equation (1),

$$Δ P = \frac{F μ T}{kA} \qquad ( 1 )$$

where ΔP is the difference in pressure across the porous medium, F is the flowrate, μ is the fluid viscosity, T is the thickness (perpendicular to the cross-sectional area), k is the permeability, and A is the cross-sectional area of the porous media.

FIGS. 4A and 4B illustrate embodiments of operating environments 400A, 400B that may be representative of various embodiments. In operating environments 400A, 400B, a flow splitter is represented as a tee resistor for electrical currents. In operating environment 400A, inlet filter 104 may be represented by filter resistance 404, restrictor 108-1 may be represented by restrictor resistance 408-1, and restrictor 108-1 may be represented by restrictor resistance 408-2. Operating environment 400B may be the same or similar to operating environment 400A, except for the addition of downflow resistance 410-1 and downflow resistance 410-2. In various embodiments, downflow resistances 410-1, 410-2 may include one or more of tubing, sensor requirements, elevation change, or anything preventing the pressure exiting the flow splitting assembly from being at a base pressure, such as 1 atmosphere. In one or more embodiments, resistances described herein, such as with respect to FIGS. 4A-4B, may be the same or similar to predefined flow resistance values and/or combined flow resistance values. Embodiments are not limited in this context.

Referring to operating environment 400A, the split ratio in the simulated flow splitter may simply be restrictor resistance 408-1 to restrictor resistance 408-2. For instance, if restrictor resistance 408-1 was 25 and restrictor resistance 408-2 was 1, the split ratio between sub-flows 404-1A, 404-1B would be 25:1, respectively. Now referring to operating environment 400B, downflow resistances 410-1, 410-2 may be 10. Therefore, the split ratio in the simulated flow splitter would be 35:11. Accordingly, in some embodiments, resistances of restrictors may be modified considering downflow resistances. In one or more embodiments described herein restrictor resistances 408-1, 408-2, may be modified by altering one or more porous media in a flow splitting assembly, such as by adding or removing porous mediums to alter the combined flow resistance of a restrictor.

Referring back to FIG. 4A, flow 402A may enter via filter resistance 404 and exit as sub-flows 404-1A, 404-2A via restrictor resistances 408-1, 408-2, respectively. In some embodiments flow 402A may be represented as F₁, sub-flow 404-1A as F₂, and sub-flow 404-2A as F₃. Therefore,

F₁=F₂+F₃ (2)

When assuming the pressure after the flow splitter assembly is zero (for simplicity of illustration, e.g., FIG. 4A), Equations (1) and (2) can be used to determine

$${F}_{2} = \frac{{F}_{1}}{1 + ( \frac{{T}_{2}}{{T}_{3}} ) ( \frac{{k}_{{L}_{2}}}{{k}_{{L}_{3}}} ) ( \frac{{D}_{3}^{2}}{{D}_{2}^{2}} )} \qquad ( 3 )$$

It follows that the use of porous media as a means of splitting flows can be accomplished accurately, reliably, and efficiently. Further, a desired flow split can be achieved by altering parameters, such as thickness, permeability, and diameter. In various embodiments, the diameter may have an inverse relation to the rest of the parameters. For example, decreasing the diameter while increasing thickness and permeability can provide greater flow splits. Variations of split flow combinations are possible from Equation (3) and the pressure drop across the media using Mott standard flow restrictor permeability coefficients in Table 1, below.

TABLE 1

| Media | | |
|---|---|---|
| Grade | % Porous | k |
| 0.2 | 20.0 | 1.31E−07 |
| 0.5 | 23.7 | 2.92E−07 |
| 1 | 26.8 | 5.35E−07 |
| 2 | 30.4 | 9.81E−07 |
| 5 | 35.9 | 2.19E−06 |
| 10 | 40.7 | 4.01E−06 |
| 20 | 46.2 | 7.35E−06 |
| 40 | 52.4 | 1.35E−05 |
| 60 | 56.4 | 1.92E−05 |
| 100 | 61.9 | 3.01E−05 |

Utilizing porous media grade, the permeability may differ by a factor of approximately two from one media grade to the next finer media grade. In various embodiments, this may be a parameter that allows for high split ratios to be achieved.

In many embodiments, such as those utilized for HPLC or LC/MS, may require a connection to a detector or sensor that is downflow or downstream from the flow splitter. In such embodiments, the Hagen-Poiseuille relationship in Equation (4), below, can be used to determine the pressure resistance due to tubing downflow of the flow splitting assembly (e.g., downflow resistance 410-1, 410-2).

$$F = \frac{π Δ {Pr}^{4}}{8 L μ} \qquad ( 4 )$$

The relationship shows that the pressure, P, created from downflow resistance may be directly related to the flow, F, viscosity, μ, as well as, length, L, and radius, r, of the downflow tubing. In some embodiments, taking advantage of this relationship and assuming the outlet pressure from the tubing is venting to the atmosphere (i.e., 1 atmosphere), the pressure generated from the tubing may be determined as an additional parameter. In various embodiments, this may be an important consideration as the resistance is in addition to the resistance created by the flow splitter. In one or more embodiments, the combined flow resistance of each leg of a flow splitter may include the resistance created from the flow splitter and the resistance generated downstream, such as from connected microbore tubing. The increase in resistance caused by downstream tubing connected to the flow splitter can affect the resulting overall flow split. In various embodiments, a flow split of 6 to 1 may be achieved with no pressure restriction downstream. In other embodiments, a flow split of 86:1 may be achieved with no pressure restriction downstream. In another embodiment, a flow split of greater than 250:1 may be achieved with no pressure restriction downstream.

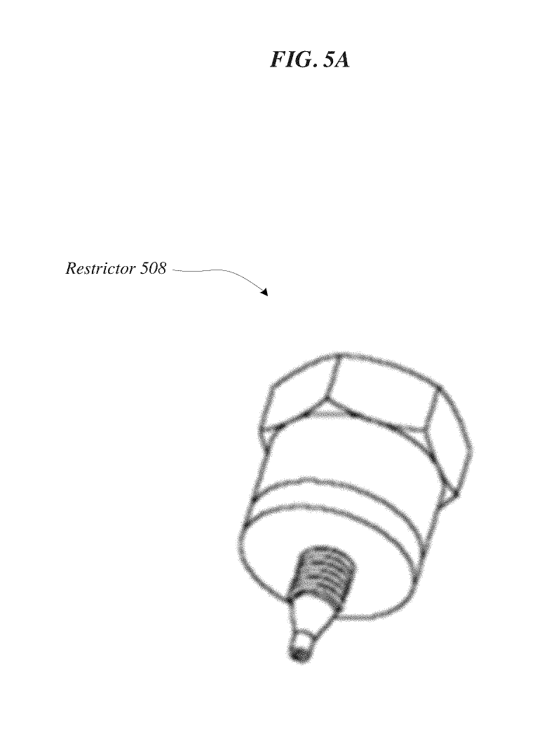

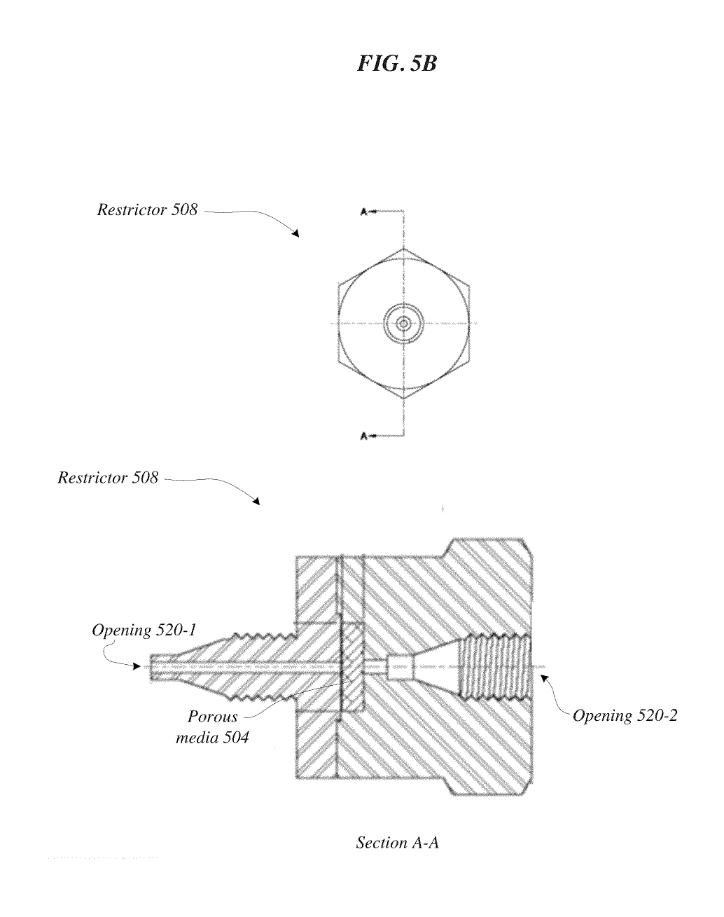

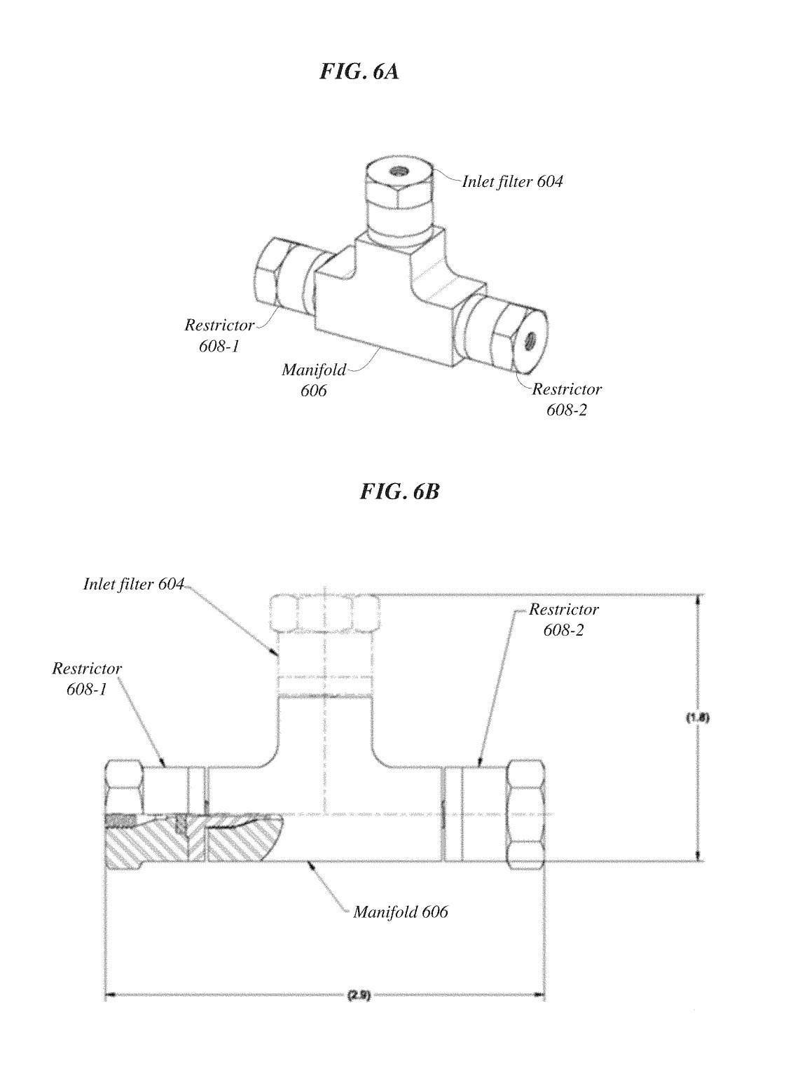

FIGS. 5A and 5B illustrate an exemplary restrictor 502 according to one or more embodiments described herein. In the illustrated embodiment, welding may be required to hold porous mediums between the two parts of hardware (see FIG. 5A). In some embodiments, this design may make it difficult to use stacked configurations of porous mediums and varying the thickness thereof to achieve desired flow splits. In one or more embodiments described herein, restrictors (e.g., restrictor 508) may have first and second openings (e.g., openings 520-1, 520-2). In one or more such embodiments, one opening may be where a flow enters the restrictor and the other opening may be where a flow exits the restrictor. FIGS. 6A and 6B illustrate an exemplary flow splitting assembly according to one or more embodiments described herein. In some embodiments, the restrictor illustrated in FIGS. 5A and 5B may be utilized by the flow splitting assembly of FIGS. 6A and 6B. Inlet filter 604 may fluidly connect to manifold 606 that splits to fluidly connect to a first restrictor 608-1 and a second restrictor 608-2. Embodiments are not limited in this context.

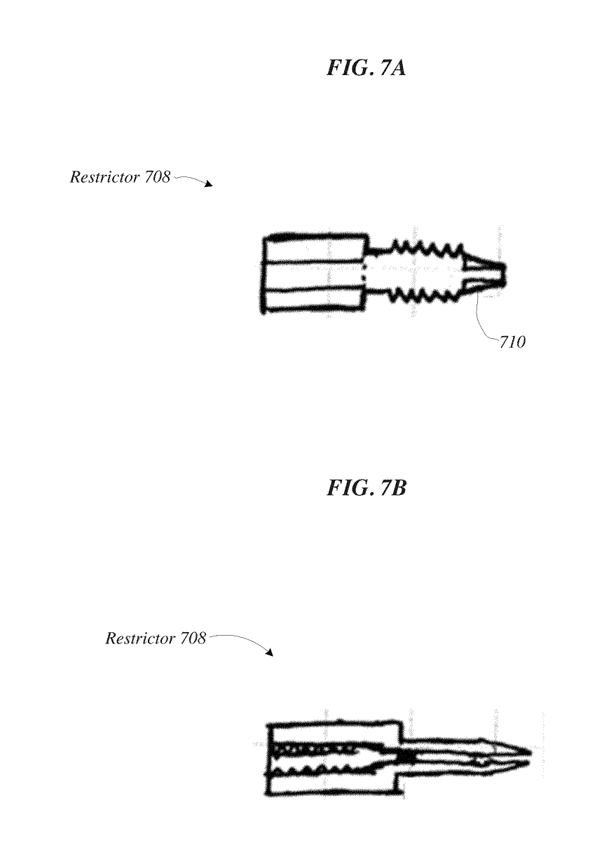

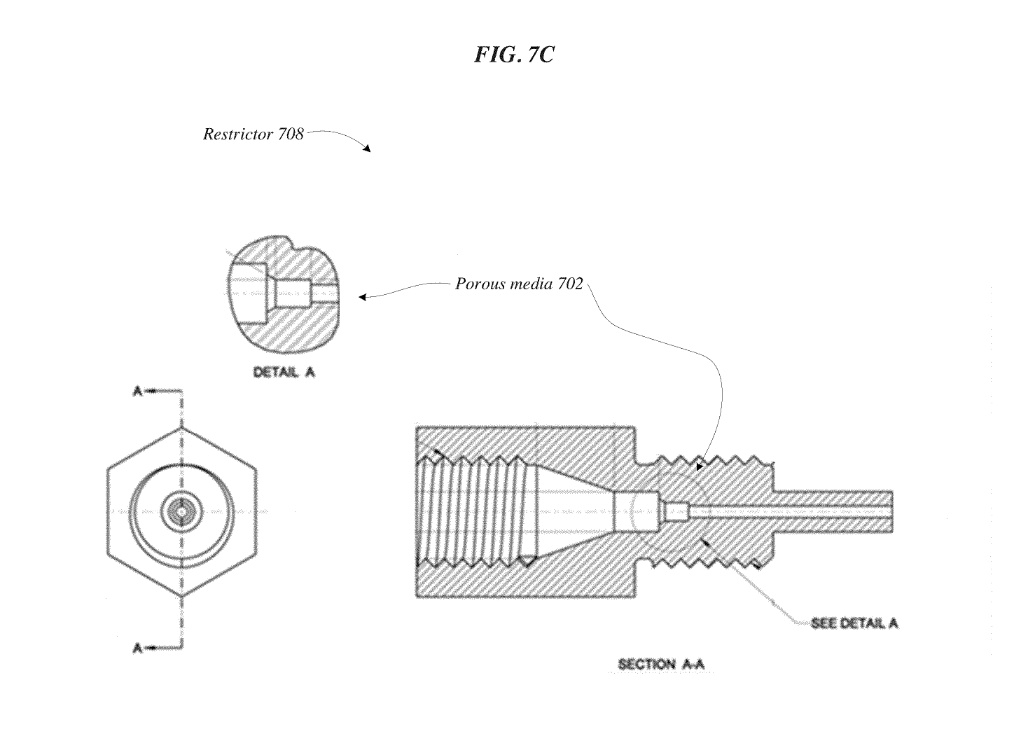

FIGS. 7A-7C illustrate an exemplary restrictor according to one or more embodiments described herein. FIG. 7A illustrates an outside view of restrictor 708; FIG. 7B illustrates a cutaway view of restrictor 708; and FIG. 7C illustrates a composite scaled drawing of restrictor 708. In various embodiments, restrictor 708 may use a standard male 10-32 HPLC thread connection on male end (right side). In some embodiments, restrictor 708 may use a PEEK tip ferrule 710 to create a finger tight seal. In one or more embodiments, the PEEK ferrule 710 may have an inclusive angle pitched at 32 degrees while a ferrule 710 seat is pitched at an inclusive angle of about 38 degrees. In one or more such embodiments, this arrangement may increase the sealing pressure and may improve robustness. In various embodiments, restrictor 708 may be utilized as an inlet filter holder. In some embodiments, if restrictor 708 was used at HPLC pressure, a seat may be added to reduce the risk of displacing porous media 702 when the flow is from right to left. Embodiments are not limited in this context.

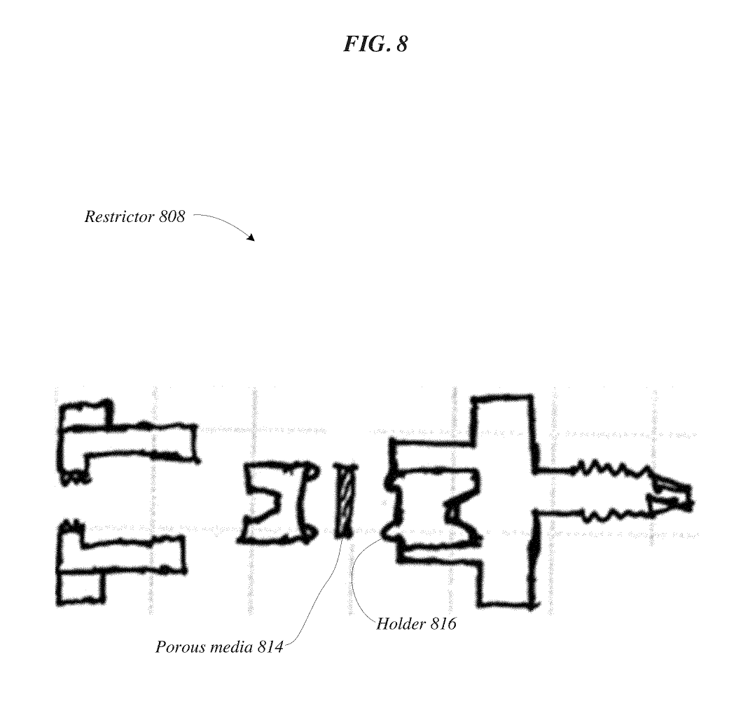

FIG. 8 illustrates an exemplary restrictor according to one or more embodiments described herein. In the illustrated embodiment, restrictor 808 be designed such that porous media 804 is crimped into holder 816. In some embodiments, restrictor 808 may enable the diameter of the porous media 814 to be altered. In various embodiments, holder 816 may be designed large enough such that the footprint would remain unchanged even though the diameter of the porous media is changed. Embodiments are not limited in this context.

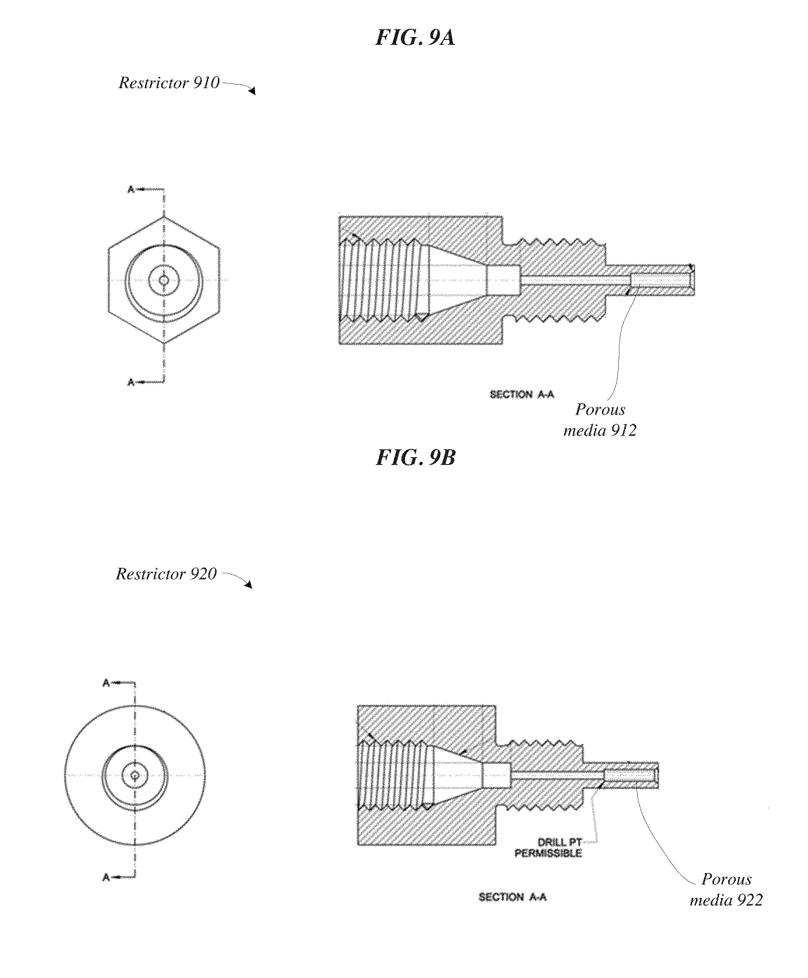

FIGS. 9A and 9B illustrate exemplary restrictors according to one or more embodiments described herein. In the illustrated embodiments, porous media 912, 922 are placed in the tip of restrictors 910, 920, respectively. In various embodiments, this may provide the porous media a seat or backing against the force of flows. In restrictor 920, knurling may be added to the hardware for the finger tight feel. FIG. 10 illustrates an exemplary ferrule 1010 according to one or more embodiments described herein. In various embodiments ferrule 1010 may comprise a PEEK ferrule. In some embodiments, pitched PEEK ferrule 1010 may be used at inclusive angles about 32 degrees and about 38 degrees. Embodiments are not limited in this context.

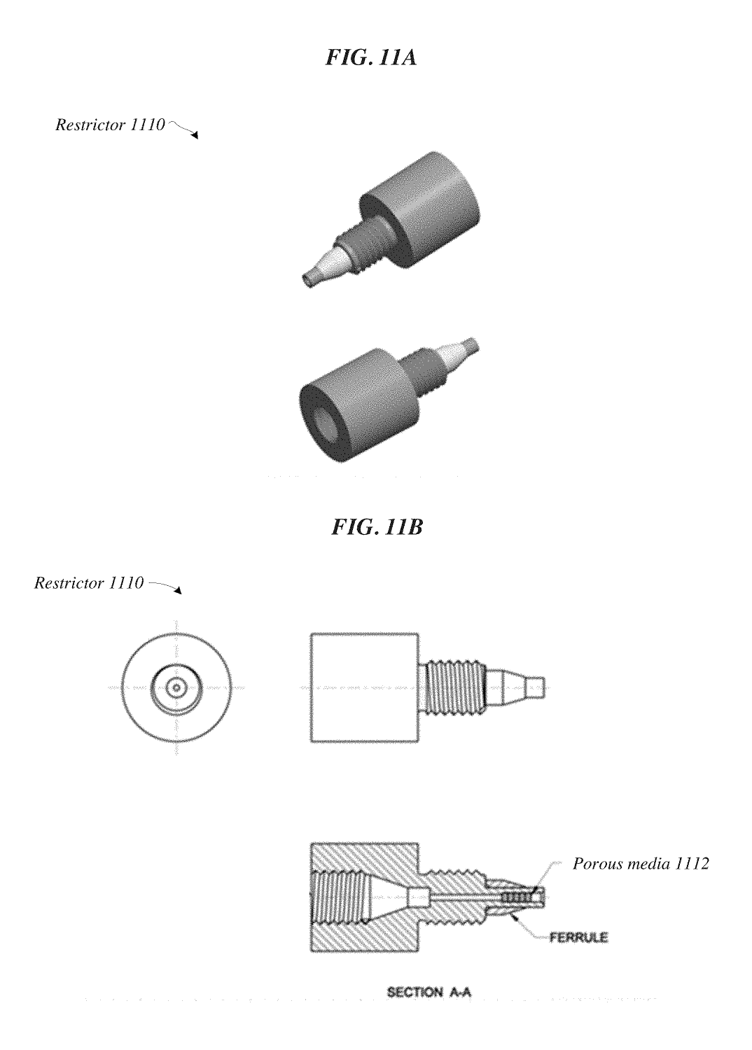

FIGS. 11A and 11B illustrate an exemplary restrictor according to one or more embodiments described herein. In various embodiments, FIGS. 11A and 11B may illustrate a complete assembly of restrictor 1110. In some embodiments, restrictor 1110 may include porous media 1112. In some such embodiment, porous media 1112 may include any number of porous mediums to achieve a desired flow split, such as four. Embodiments are not limited in this context.

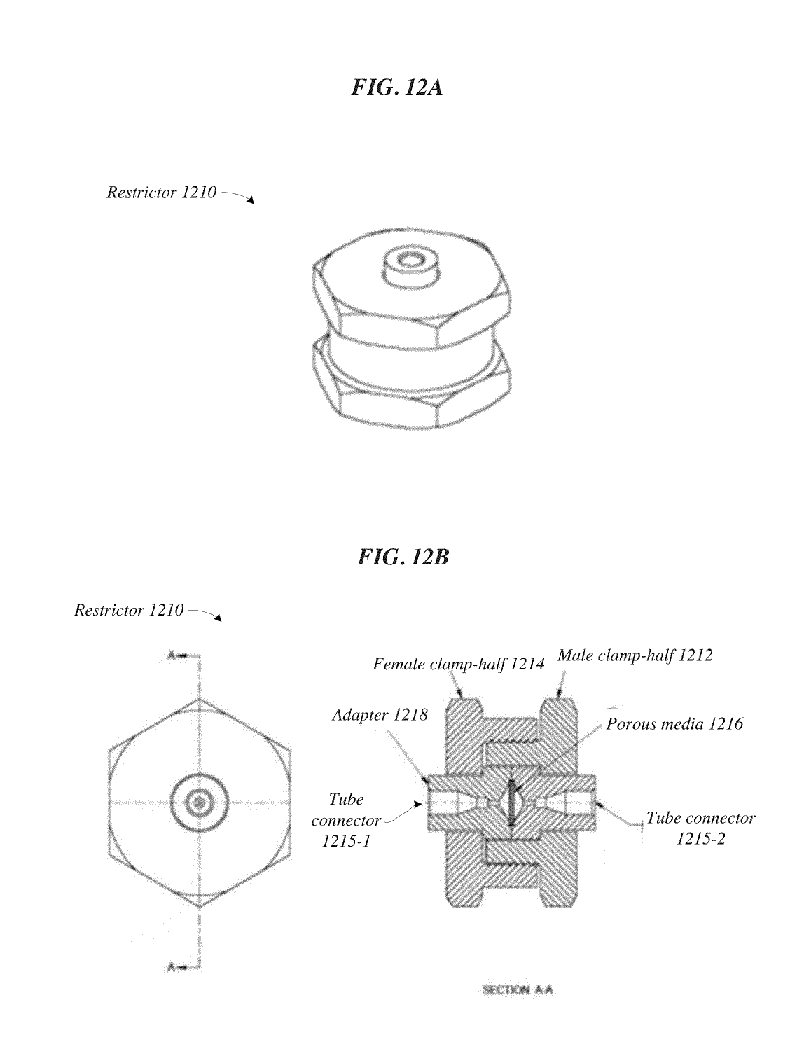

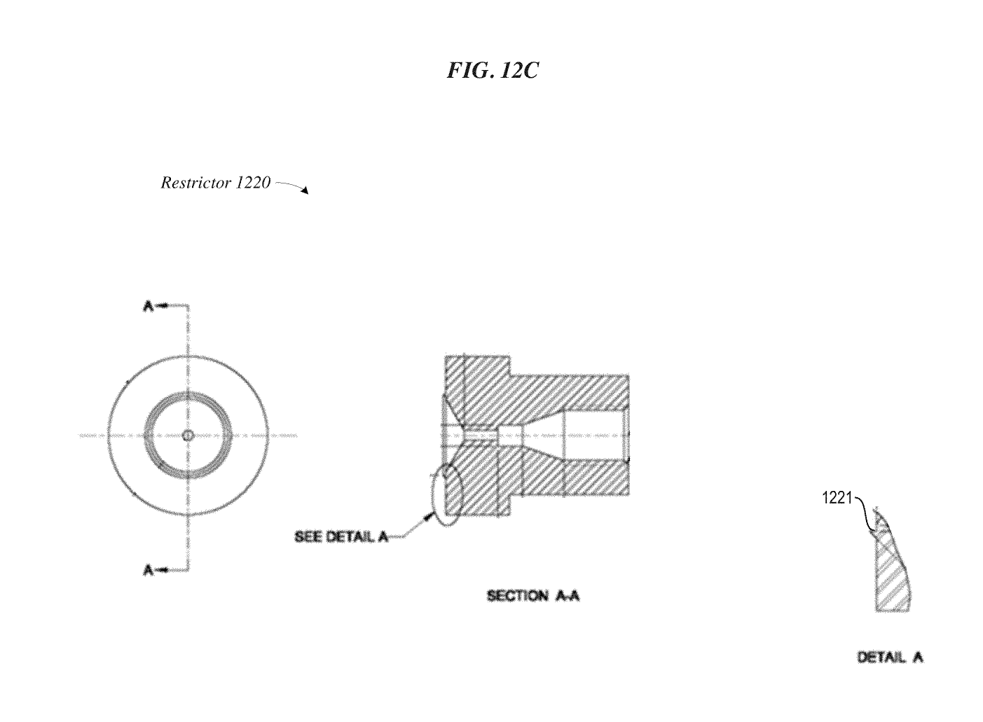

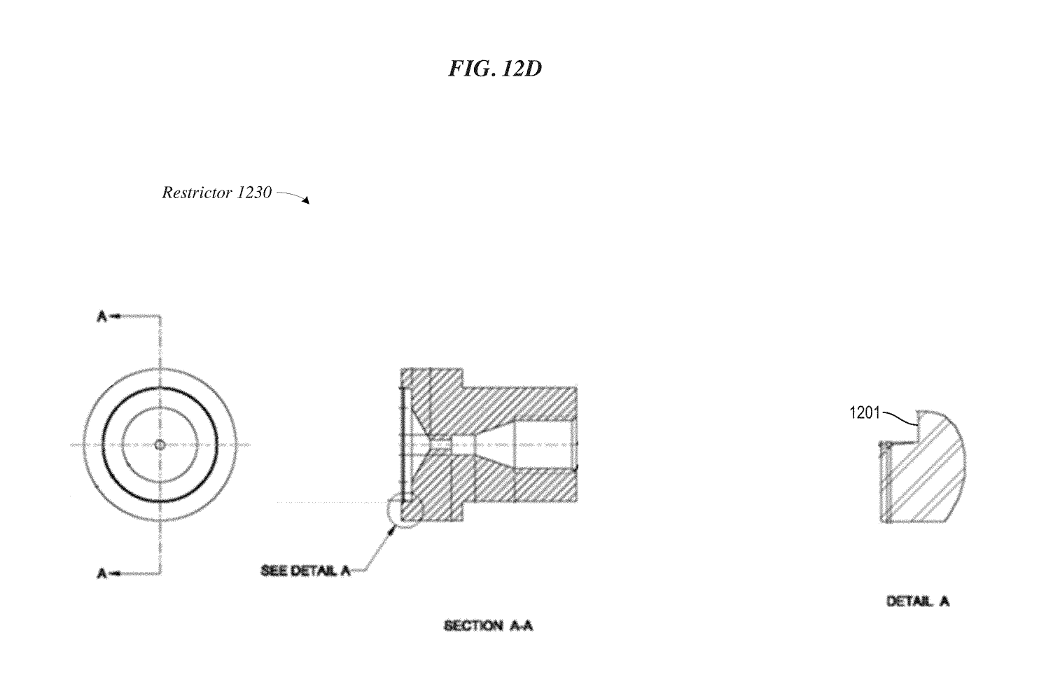

FIGS. 12A-12D illustrate exemplary restrictors according to one or more embodiments described herein. In FIGS. 12A and 12B, restrictor 1210 includes an inline filter holder assembly is shown. In such embodiments, two outer hardware (e.g., male clamp-half 1212 and female clamp-half 1214) may hold the inner two tube connectors (e.g., tube connectors 1215-1, 1215-2). FIGS. 12C and 12D illustrate restrictors 1220, 1230 with knife-like edge sealing surfaces (e.g., 1221) that deform the porous media 1216 as an outer holder (e.g., female clamp-half 1214) is compressed down. A shelf 1201 may assist in retaining the porous media 1216. Embodiments are not limited in this context.

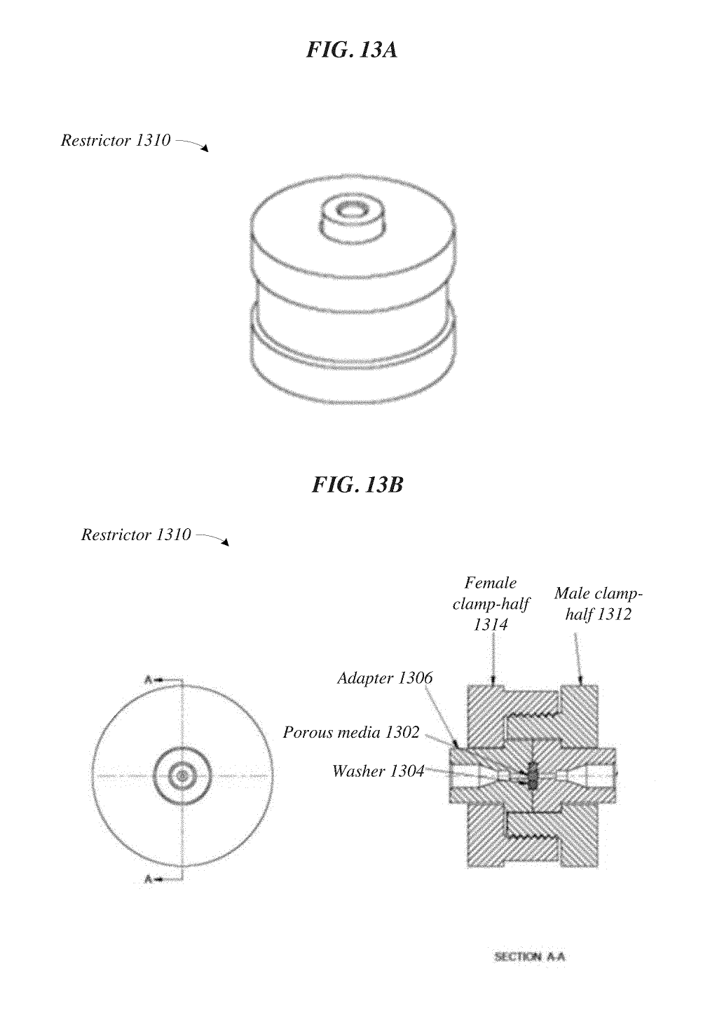

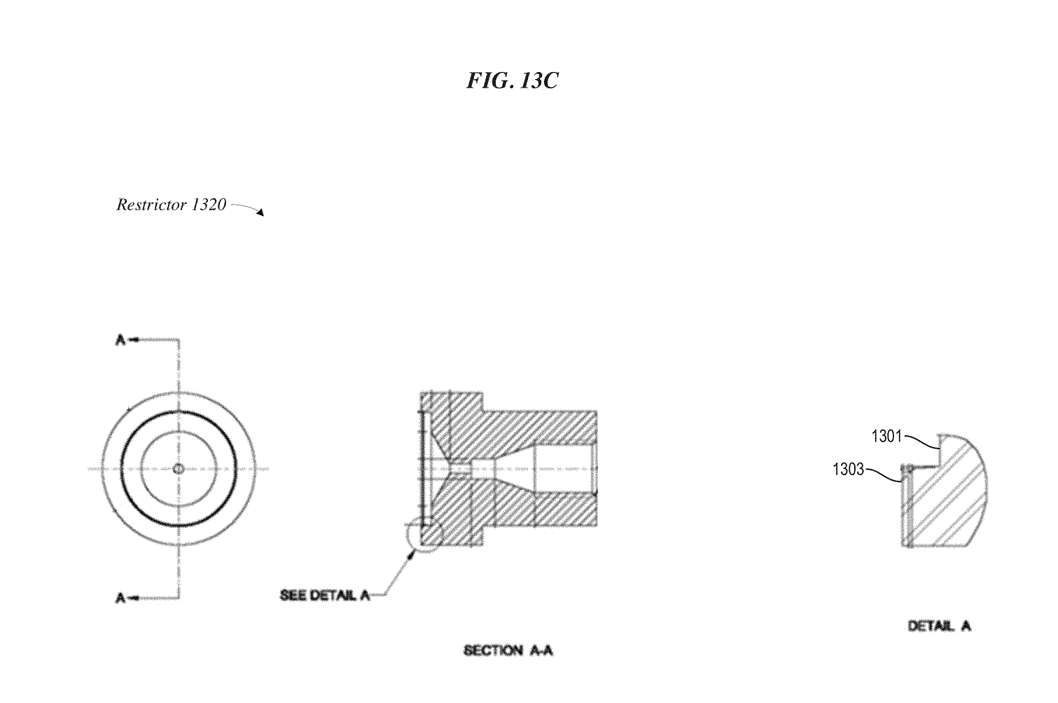

FIGS. 13A-13C illustrate exemplary restrictors according to one or more embodiments described herein. In some embodiments, restrictor 1310 of FIGS. 13A and 13B may be the same or similar to restrictor 1210 of FIGS. 12A and 12B. In various embodiments, restrictor 1310 may include a finger tight knurling on the outer hardware. A female clamp-half 1314 may couple to a male clamp-half 1312 to contain an adapter 1306 that includes a porous media 1302 and a washer 1304. In FIG. 13C, restrictor 1320 may include an interior tube connector with a shelf 1301 to hold porous media with an interference edge 1303. In one or more embodiments, as the exterior hardware is collapsed the porous media will collapse on the outer edge and deform, densifying the outer edge of the disc. Embodiments are not limited in this context.

Furthermore, derived from Equation (3) we can incorporate the downstream resistance contribution from the tubing described above (See e.g., [0051]). Combining Equation (3) and Equation (4) and solving for the ratio of flow in one leg relative to the ratio of flow in another leg we can arrive at Equation (5) to predict the flow split based on the resistance contribution from the splitter with the resistance contribution from the downstream tubing. Equation (5) is as follows:

$$\frac{{F}_{2}}{{F}_{3}} = \frac{( \frac{{L}_{{T}_{3}}}{π {R}_{3}^{4}} + \frac{{L}_{{R}_{3}}}{{k}_{{R}_{3}} {A}_{{R}_{3}}} )}{( \frac{{L}_{{T}_{2}}}{π {R}_{2}^{4}} + \frac{{L}_{{R}_{2}}}{{k}_{{R}_{2}} {A}_{{R}_{2}}} )} \qquad ( 5 )$$

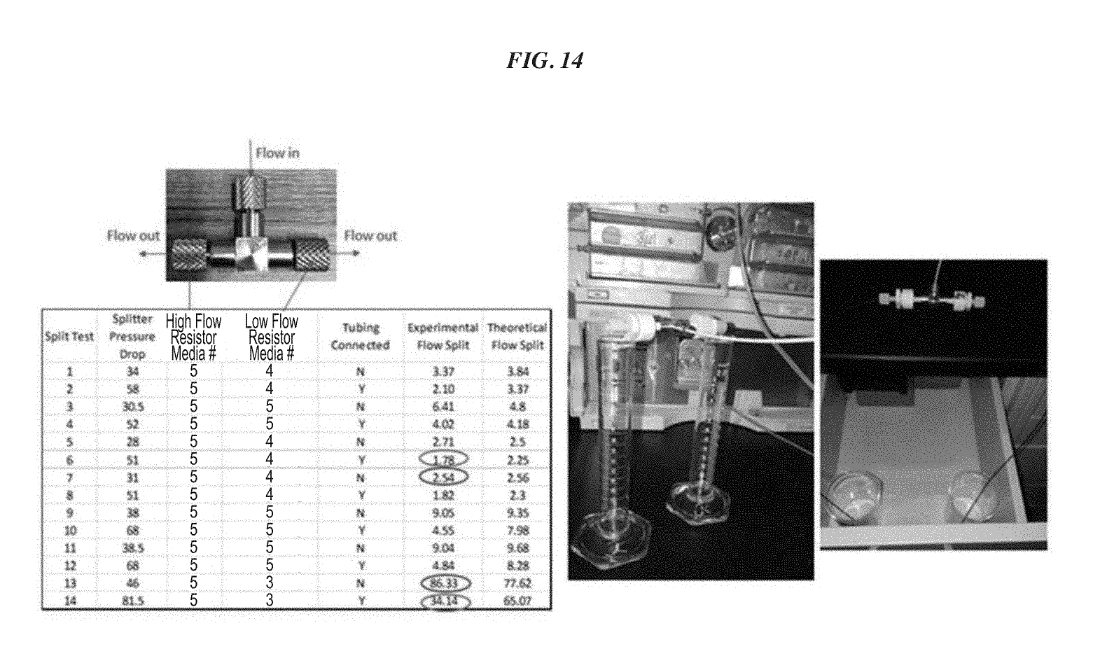

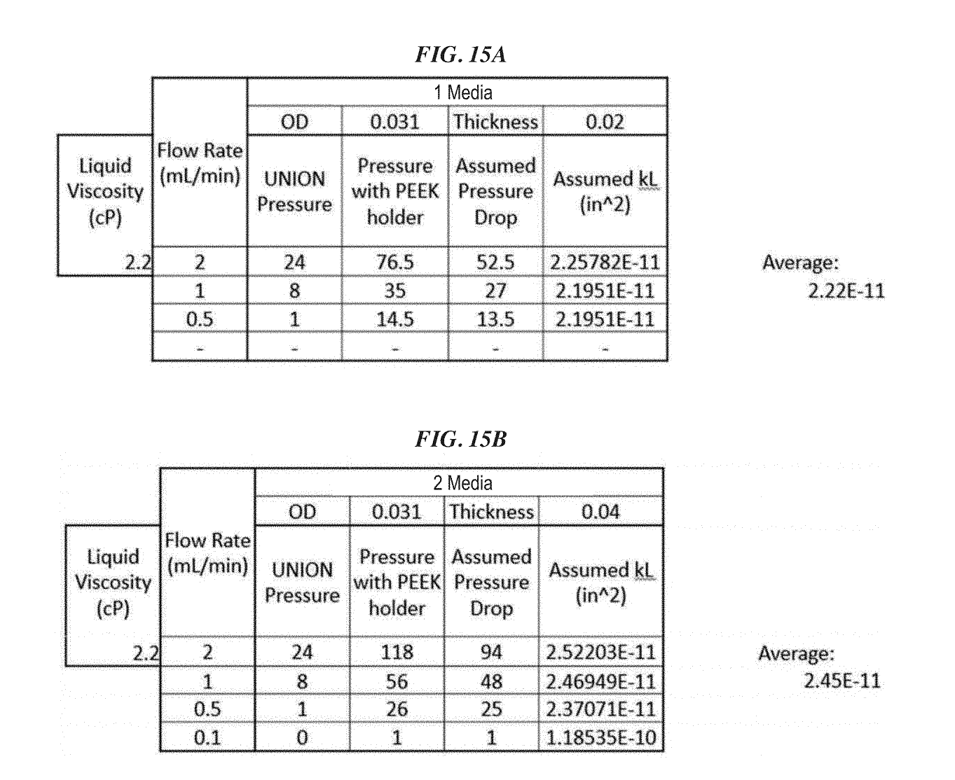

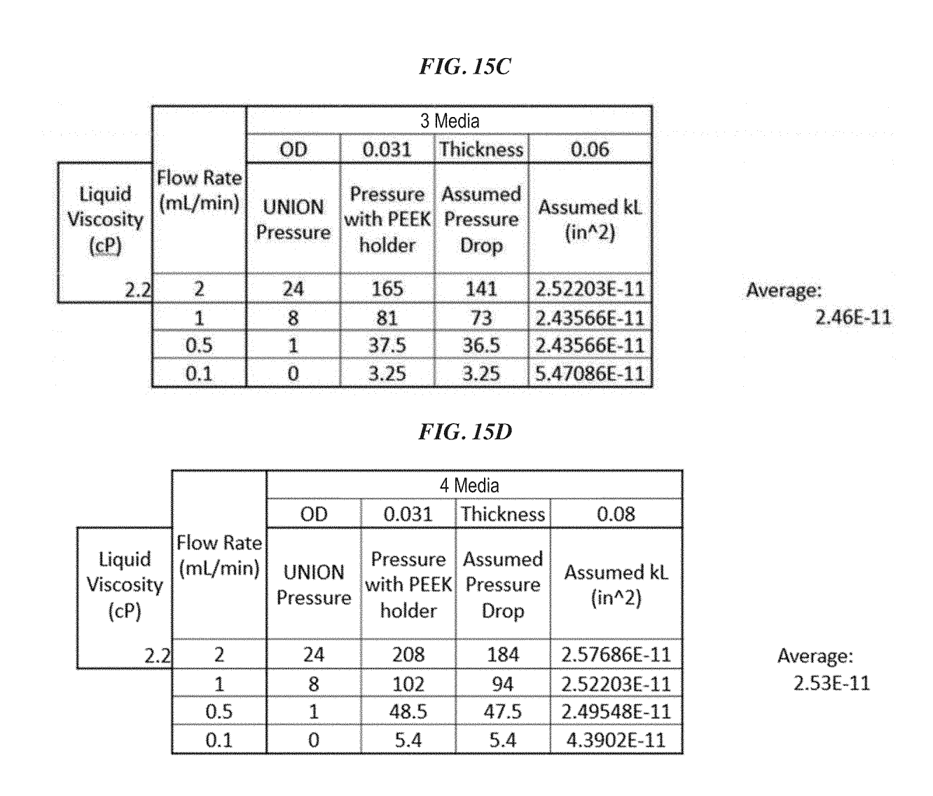

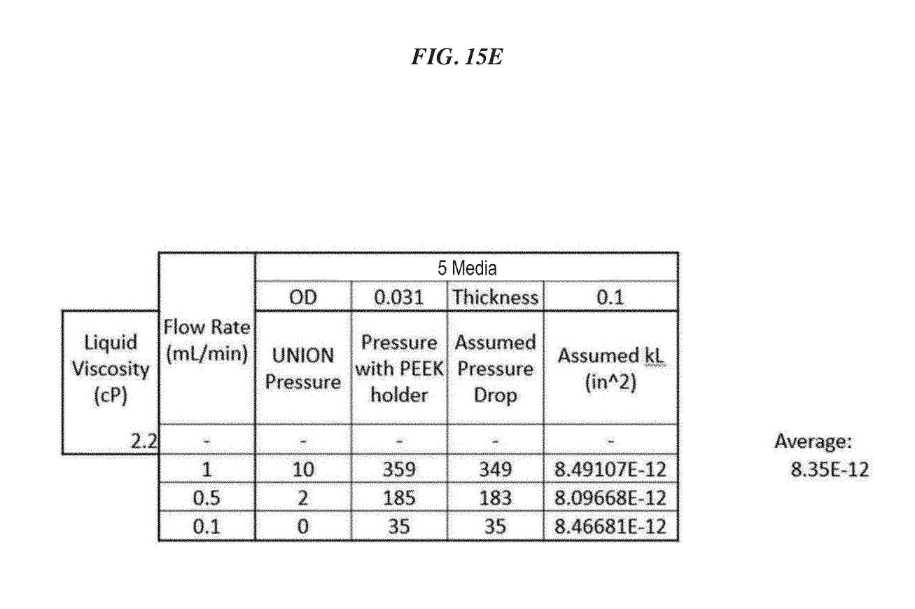

Deriving Equation (5) allows for the prediction of flow split with and without the contribution of the downstream resistance from the tubing. The predicted values are shown in FIG. 14 under theoretical flow split. This is not a completely theoretical calculation, as it relies on the experimental determination of the permeability value k_{R} for the given resistor found as an example in FIGS. 15A-15E.

Experimental flow split data was collected using many different porous resistor configurations. The data collected is shown in FIG. 14. The resistor configurations are noted first by the number of stacked restrictors, then second by the media grade of that restrictor, giving a specific permeability value. An example of permeability data is shown in FIGS. 15A-15E. A stack of restrictors in series may increase the pressure drop across the given restrictor body. Increasing this pressure drop will directly increase the resistance across the resistor, resulting in increased accuracy when splitting flow as well as achieving higher flowrate splits than with less restrictors in series. An example of this is evident in split test 13 shown in FIG. 14. Test 13 utilizes a high flow restrictor that is comprised of 5 fine media restrictors. The pressure drop across this resistor is roughly 35 bar at 1 mL/minute with isopropyl alcohol, and is designed to help mitigate the contribution of the downstream tubing that is connected to the splitter adding additional resistance to each leg of the splitter. The low flow resistor is comprised of various density porous media resistors. The pressure drop across this restrictor at the given test conditions above is roughly 1000 bar. In experimental testing this configuration delivered roughly an 85 to 1 flow split, slightly higher than our predicted flow split of 77 to 1. Also, evident in FIG. 14 is the effect on the flow split as 16 inches of capillary tubing is connected downstream of the splitter. The circled “Experimental Flow Split” values of 2.54 and 86.33 are the minimum and maximum values respectively without tubing. The circled “Experimental Flow Split” values of 1.78 and 34.14 are the minimum and maximum values respectively with tubing.

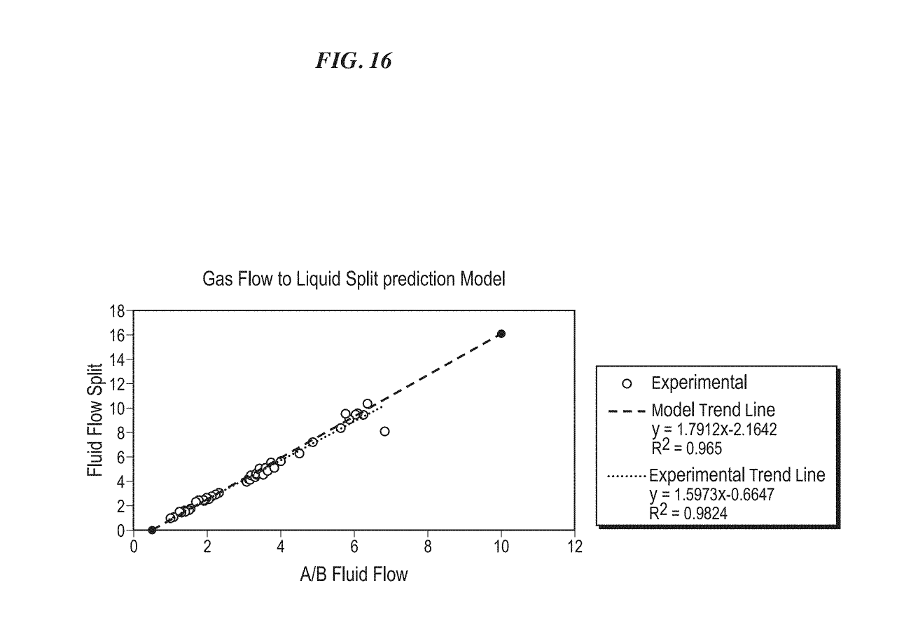

FIG. 16 illustrates a graphical representation of data associated with flow splitting according to one or more embodiments described herein. Such data may be obtained from various embodiments of flow splitting assemblies by a method of measuring a fluid flowrate egressing through a first restrictor (e.g., “restrictor A”) and a second restrictor (e.g., “restrictor B”). The fluid for such testing may be a gas, which typically requires less auxiliary fixtures than when testing with liquid (e.g., exhaust/return plumbing extending out of the first and second restrictors). The independent variable of FIG. 20 is a unitless ratio of the flowrate of restrictor A divided by the flowrate of restrictor B of a flow splitting assembly. The dependent variable is a “flow split” value of the flow splitting assembly. The flow split value of a flow splitting assembly may be tested and measured before installing the flow splitting assembly into a product or other fixture. If an undesirable flow split value is measured, the flow splitting assembly may be removed from the manufacturing line or batch, saving the cost of a full installation of a faulty flow splitting assembly. The “Model Trend Line” is found by testing the flow splitting assemblies with a flow of gas. This gas “Model Trend Line” may also predict the flow split of assemblies using a liquid. The independent data points “Experimental” are a fluid flow rate of a first restrictor (e.g., restrictor A) divided by a second restrictor (e.g., restrictor B) using liquid. The dependent variable is a flow split value of the flow splitting assembly using a flow of liquid. The “Experimental Trend Line” is the trend line of the liquid flow “Experimental” data. The “Experimental Trend Line” of the liquid flow “Experimental” data points closely matches the “Model Trend Line” found with a flow of gas. Therefore, testing various embodiments with gas may predict their flow splitting behavior when flowed with liquid and/or other fluids.

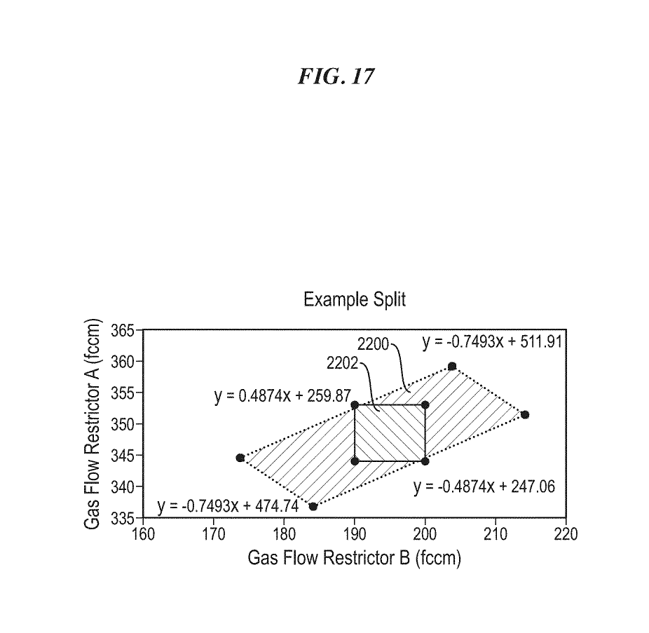

FIG. 17 illustrates a graphical representation of data associated with flow splitting according to one or more embodiments described herein. To ensure flowrates through a first restrictor (i.e., restrictor A in standard cubic centimeters per minute (fccm)) and a second flow restrictor (i.e., restrictor B in fccm) result in a specified split flow rate of their combined assembly, a manufacturing tolerance for restrictors A and B may be calculated. For example, the limits of a desired flow split specification may allow for the flow rates of restrictor A and restrictor B to be within the specification area 2200. The vertical (y-value) limits of the specification area 2200 are the acceptable ranges of the flow rates for restrictor A. The horizontal (x-value) limits of the specification area 2200 are the acceptable ranges of flow rates for restrictor B. This rhombus-shaped specification area 2200 may be calculated, for example, by selecting a range of desirable flow values of the assembly of restrictors A and B. Solving for the limits, the resulting specification area 2200 is the boundary flow rate values for restrictors A and B having a ratio (i.e., A divided by B) within the range of the desirable flow splits of the assembly. The specification area 2200 represents an assembly of restrictor A with restrictor B that will yield a split flow rate of the assembly within the desired specification. Any specific pairing of restrictor A (y-value) with restrictor B (x-value) within the specification area 2200 may produce a valid flow split for the specification. However, this specification area 2200 may be reduced to a manufacturing area 2202 by creating a central square area tolerance range for manufacturing the restrictor A and B parts. The manufacturing area 2202 allows for a pairing of any flow restrictor A with any flow restrictor B (each within the manufacturing area 2202) to result in a flow split that meets the specification. Flow rate values for restrictor A and B that fall within the manufacturing area 2202 allow for tolerable variance in manufacturing these parts while still meeting the specification of flow rates (i.e., the split flow of the assembly, the flow rate of restrictor A, and the flow rate of restrictor B).

In various embodiments, a method for splitting fluid flows with porous media may include introducing a fluid flow to a manifold via an inlet filter. The manifold may include a first, a second, and a third manifold opening in fluid communication with each other. The inlet filter may be coupled to the first manifold opening. A first restrictor may include a first porous media coupled to the second manifold opening. A second restrictor may include a second porous media coupled to the third manifold opening. A differential fluid flow may be caused at a calibrated flow split between the first and second restrictors. The differential flow may include a first sub-flow through the first restrictor and a second sub-flow through the second restrictor.

In various embodiments, a method of manufacturing a flow restrictor may include compressing metal powder particles into a first porous medium. The first porous medium may have a first predefined flow resistance value. The metal powder particles may be compressed into a second porous medium. The second porous medium may have a second predefined flow resistance value that may be different than the first predefined flow resistance value. The first porous medium and the second porous medium may be disposed in an interior volume of a restrictor. The restrictor may include first and second openings in fluid communication via the interior volume. The metal powder particles may be compressed into the first porous medium as part of a first sintering process based on the first predefined flow resistance value. The metal powder particles may be compressed into the second porous medium as part of a second sintering process based on the second predefined flow resistance value. The first porous medium may include a first cylinder with a diameter and a first thickness. The first thickness may be perpendicular to the diameter. The second porous medium may include a second cylinder with a diameter and a second thickness. The second thickness may be perpendicular to the diameter. The first thickness may be based on the first predefined flow resistance value. The second thickness may be based on the second predefined flow resistance value. The metal powder particles may be compressed into the first porous medium with a first pressing force based on the first predefined flow resistance value. The metal powder particles may be compressed into the second porous medium with a second pressing force based on the predefined flow resistance value. One or more dimensions of the first porous medium may be determined based on the first predefined flow resistance value. One or more dimensions of the second porous medium may be determined based on the second predefined flow resistance value. The metal powder particles may include stainless steel. The first porous medium and the second porous medium may be disposed in series. The first porous medium and the second porous medium may be disposed by stacking the first porous medium and the second porous medium in the interior volume. The first porous medium and the second porous medium may have a cylindrical shape. The first porous medium and the second porous medium may include at least one surface with matching dimensions. A size in a dimension perpendicular to the surface with matching dimensions may be determined based on the first and second predefined flow resistance values, respectively.

The foregoing description of example embodiments has been presented for the purposes of illustration and description. It is not intended to be exhaustive or to limit the present disclosure to the precise forms disclosed. Also, one or more components described with respect to one or more embodiments may be utilized in one or more other embodiments. For instance, restrictor 108-1 may include or utilize restrictor 502, restrictor 708, etcetera. Additionally, changes may be made to one or more components described with respect to one or more embodiments to enable them to be incorporated into one or more other embodiments without departing from the scope of this disclosure. For example, if restrictor 708 were utilized as an inlet filter holder. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed is:

1. An apparatus for flow splitting, comprising:
a manifold comprising first, second, and third manifold openings in fluid communication with each other;
an inlet filter coupled to the first manifold opening;
a first restrictor coupled to the second manifold opening, the first restrictor comprising a first porous media;
a second restrictor coupled to the third manifold opening, the second restrictor comprising a second porous media; and
wherein introduction of a fluid flow to the manifold via the inlet filter causes a differential flow at a calibrated flow split between the first and second restrictors, the differential flow comprising a first sub-flow through the first restrictor and a second sub-flow through the second restrictor.

2. The apparatus of claim 1, wherein the first porous media and the second porous media comprise porous metal.

3. The apparatus of claim 2, wherein the porous metal comprises stainless steel.

4. The apparatus of claim 2, wherein the porous metal comprises porous metal sinterable particles including a metal or metal alloy selected from the group consisting of nickel, cobalt, iron, copper, palladium, titanium, platinum, silver, and gold.

5. The apparatus of claim 2, wherein at least one of the first porous media and second porous media comprise a polymer material.

6. The apparatus of claim 2, wherein at least one of the first porous media and the second porous media comprise ceramic or glass material.

7. The apparatus of claim 1, wherein the first porous media comprises a first set of one or more porous mediums and the second porous media comprises a second set of one or more porous mediums, each porous medium in the first and second sets associated with a predefined flow resistance value.

8. The apparatus of claim 7, wherein the calibrated flow split between the first and second restrictors is based on a ratio of a first combined flow resistance value of the first sub-flow to a second combined flow resistance value of the second sub-flow.

9. The apparatus of claim 8, wherein:
the first combined flow resistance value is based on the predefined flow resistance values of each porous medium in the first set; and
the second combined flow resistance value is based on the predefined flow resistance values of the second set.

10. The apparatus of claim 9, wherein the first combined flow resistance value is based on a first downflow resistance in fluid communication with the first restrictor.

11. The apparatus of claim 10, wherein the second combined flow resistance value is based on a second downflow resistance in fluid communication with the second restrictor.

12. The apparatus of claim 11, wherein one or more of the first and second downflow resistances comprises tubing.

13. The apparatus of claim 7, wherein the one or more porous mediums in the first set are arranged in series and the one or more porous mediums in the second set are arranged in series.

14. The apparatus of claim 13, wherein the first set of porous mediums are arranged in parallel with the second set of porous mediums.

15. The apparatus of claim 7, wherein each porous medium in the first and second sets comprise porous metal.

16. The apparatus of claim 15, wherein the porous metal comprises stainless steel.

17. The apparatus of claim 1, wherein:
the first restrictor comprises first and second restrictor openings in fluid communication via a restrictor interior volume; and
the first restrictor opening is coupled to the second manifold opening and the first porous media is disposed within the restrictor interior volume.

18. The apparatus of claim 17, wherein the second restrictor opening is coupled to a tube in fluid communication with a sensor.

19. The apparatus of claim 1, wherein the first porous media comprises a powder of metal particles.

20. The apparatus of claim 19, wherein the powder of metal particles are compressed into a cylindrical or disc shape.

21. The apparatus of claim 1, wherein a flowrate, F₁, of the flow and a flowrate, F₂, of the first sub-flow have the following relationship with a thickness, T₂, of the first porous medium, a thickness, T₃, of the second porous medium, a permeability, k_{L}_{₂}, of the first porous medium, a permeability, k_{L}_{₃}, of the second porous medium, a diameter of the first porous medium, and a diameter of the second porous medium:
$${F}_{2} = \frac{{F}_{1}}{1 + ( \frac{{T}_{2}}{{T}_{3}} ) ( \frac{{k}_{{L}_{2}}}{{k}_{{L}_{3}}} ) ( \frac{{D}_{3}^{2}}{{D}_{2}^{2}} )} .$$

22. The apparatus of claim 1, further comprising a polyether ether ketone (PEEK) configured to form a seal between one or more of the inlet filter and the first manifold opening, the first restrictor and the second manifold opening, and the second restrictor and the third manifold opening.

23. The apparatus of claim 22, wherein the seal comprise a high-pressure seal of at least 10,000 pounds per square inch (PSI).

24. The apparatus of claim 1, wherein the first porous media and the second porous media comprise stainless steel.

25. The apparatus of claim 1, further comprising a pre-column splitter that includes the manifold, the first restrictor, and the second restrictor.

26. The apparatus of claim 1, further comprising a post-column splitter that includes the manifold, the first restrictor, and the second restrictor.

27. A method for flow splitting, comprising:
introducing a fluid flow to a manifold via an inlet filter, the manifold comprising first, second, and third manifold openings in fluid communication with each other, the inlet filter coupled to the first manifold opening, a first restrictor comprising a first porous media coupled to the second manifold opening, and a second restrictor comprising a second porous media coupled to the third manifold opening; and
causing a differential fluid flow at a calibrated flow split between the first and second restrictors, the differential flow comprising a first sub-flow through the first restrictor and a second sub-flow through the second restrictor.

28. A method of manufacturing a flow restrictor, comprising the steps of:
compressing metal powder particles into a first porous medium, the first porous medium having a first predefined flow resistance value;
compressing metal powder particles into a second porous medium, the second porous medium having a second predefined flow resistance value different than the first predefined flow resistance value; and
disposing the first porous medium and the second porous medium in an interior volume of a restrictor, the restrictor including first and second openings in fluid communication via the interior volume.

29. The method of claim 28, further comprising compressing metal powder particles into the first porous medium as part of a first sintering process based on the first predefined flow resistance value and compressing metal powder particles into the second porous medium as part of a second sintering process based on the second predefined flow resistance value.

30. The method of claim 28, wherein the first porous medium comprises a first cylinder with a diameter and a first thickness, the first thickness perpendicular to the diameter, and the second porous medium comprising a second cylinder with the diameter and a second thickness, the second thickness perpendicular to the diameter, wherein the first thickness is based on the first predefined flow resistance value and the second thickness is based on the second predefined flow resistance value.

31. The method of claim 28, further comprising compressing metal powder particles into the first porous medium with a first pressing force based on the first predefined flow resistance value and compressing metal powder particles into the second porous medium with a second pressing force based on the predefined flow resistance value.

32. The method of claim 28, further comprising determining one or more dimensions of the first porous medium based on the first predefined flow resistance value and one or more dimensions of the second porous medium based on the second predefined flow resistance value.

33. The method of claim 28, wherein the metal powder particles comprise stainless steel.

34. The method of claim 28, further comprising disposing the first porous medium and the second porous medium in series.

35. The method of claim 28, further comprising disposing the first porous medium and the second porous medium by stacking the first porous medium and the second porous medium in the interior volume.

36. The method of claim 28, wherein the first porous medium and the second porous medium comprise a cylindrical shape.

37. The method of claim 28, wherein the first porous medium and the second porous medium comprise at least one surface with matching dimensions, wherein a size in a dimension perpendicular to the surface with matching dimensions is determined based on the first and second predefined flow resistance values, respectively.
